(19) United States
(12) Patent Application Publication
(10) Pub. No.: US 2025/0087402 A1
(43) Pub. Date: Mar. 13, 2025

(54) HIGH ISOLATION MEDIUM FREQUENCY TRANSFORMER

(71) Applicant: BOARD OF REGENTS, THE UNIVERSITY OF TEXAS SYSTEM, Austin, TX (US)

(72) Inventors: Qin Huang, Austin, TX (US); Zhicheng Guo, Austin, TX (US)

(21) Appl. No.: 18/830,109

(22) Filed: Sep. 10, 2024

Related U.S. Application Data
(60) Provisional application No. 63/581,662, filed on Sep. 10, 2023.

(51) Int. Cl. H01F 27/08; H01F 27/02; H01F 27/24; H01F 27/28; H01F 41/02; H01F 41/06

(52) U.S. Cl. CPC H01F 27/085; H01F 27/02; H01F 27/24; H01F 27/28; H01F 41/0206; H01F 41/06

(57) ABSTRACT

An exemplary finned transformer and method of use and fabrication are disclosed that employ an insulation structure comprising a bobbin with finned cooling structures that can improve the thermal conduction of the heat-generating portion of the transformer without use of active cooling loops. The finned bobbins may be employed in conjunction with potted windings. In some embodiments, bobbins with heatsink fins are manufactured with 3D printing or additive manufacturing. In other embodiments, the bobbins with heatsink fins can be cast or manufactured using conventional manufacturing techniques. The cooling structure may be implemented in a dielectric structure situated between the windings of the transformer.

### CROSS-REFERENCE TO RELATED APPLICATIONS

This application claims priority to U.S. Provisional Patent Application No. 63/581,662, filed Sep. 10, 2023, which is incorporated herein by reference in its entirety.

### GOVERNMENT LICENSED RIGHTS

This invention was made with government support under Grant no. DE-OE0000905 awarded by the Department of Energy. The government has certain rights in the invention.

### BACKGROUND

A transformer is an electrical equipment used to step up or step down the electrical voltages. Transformers can generate heat during operation due to resistive loss (I²R loss), hysteresis losses, and eddy current losses.

Large transformers can be cooled using radiators and fans as well pumps, for example, to circulate oil, air, or water through the transformer and an external heat exchanger or cooler.

There are still benefits to improving the thermal and insulation performance of transformers.

### SUMMARY

An exemplary finned transformer and method of use and fabrication are disclosed that employ an insulation structure comprising a bobbin with finned cooling structures that can improve the thermal conduction of the heat-generating portion of the transformer without use of active cooling loops.

The finned bobbins may be employed in conjunction with potted windings. In some embodiments, bobbins with heatsink fins are manufactured with 3D printing or additive manufacturing. In other embodiments, the bobbins with heatsink fins can be cast or manufactured using conventional manufacturing techniques. The cooling structure may be implemented in a dielectric structure situated between the windings of the transformer.

In an aspect, an apparatus (e.g., transformer) is disclosed comprising: a magnetic core having a first arm and a second arm; a first conductor that wraps around the first arm of the magnetic core; a second conductor that wraps around the second arm of the magnetic core; and a casing structure comprising a dielectric or insulating material that surrounds the first conductor and the second conductor, the casing structure having (i) a first casing member that is placed in proximity to the first arm of the magnetic core and (ii) a second casing member that is placed in proximity to the second arm of the magnetic core, wherein at least one of the first casing member or the second casing member includes a set of finned structures, including a first fin and a second fin, that extends therefrom.

The finned structure improves the thermal operation of the transformer and allows for higher power/thermal density operation using active or passive air-cooled components.

In some embodiments, the first fin and second fin each have a cooling surface that extends along a portion of the first casing member (e.g., in a parallel manner of the first arm).

In some embodiments, the set of finned structures each has a cooling surface that extends along a portion of the first casing member (e.g., in a parallel configuration to the first arm) to form a set of cooling channels.

In some embodiments, the first fin and second fin each have a cooling surface that extends along the portion of the first casing member in a parallel configuration to the first arm.

In some embodiments, the first fin and second fin each have a cooling surface that extends along the portion of the first casing member in a non-parallel configuration to the first arm.

In some embodiments, the apparatus includes a third casing member (e.g., inner casing structure for the first arm) that is placed in proximity to the first arm of the magnetic core and in between the first arm and the first conductor and a fourth casing member (e.g., inner casing structure for the second arm) that is placed in proximity to the second arm of the magnetic core and in between the second arm and the second conductor, wherein at least one of the third casing member or the fourth casing member includes a second set of finned structures, including a third fin and a fourth fin, that extends therefrom.

In some embodiments, the third casing member and the fourth casing member form a second casing structure, the second casing structure having an air gap between the third casing member and the fourth casing member.

In some embodiments, the third casing member and the fourth casing member form a second casing structure, the second casing structure having a dielectric material in between the third casing member and the fourth casing member.

In some embodiments, the apparatus further includes a third casing member (e.g., inner casing structure for the first arm) that is placed in proximity to the first arm of the magnetic core and in between the first arm and the first conductor and a fourth casing member (e.g., inner casing structure for the second arm) that is placed in proximity to the second arm of the magnetic core and in between the second arm and the second conductor, wherein the third casing member and second casing member, wherein at least one of the first casing member or the second casing member includes a set of finned structures, including a first fin and a second fin, that extends therefrom.

In some embodiments, the apparatus further includes a third casing structure (e.g., inner cooling bobbin for the first arm) comprising a dielectric or insulating material that surrounds the first arm in between the first arm and the first conductor, wherein the third casing structure includes: (i) a fifth casing member that is placed in proximity to the first conductor and (ii) a sixth casing member that is placed in proximity to the first conductor, wherein the fifth casing member operatively connects to the sixth casing member to form a second enclosed structure around the first arm and in between the first arm and the first conductor, wherein at least one of the fifth casing member or the sixth casing member includes a third set of finned structures, including a fifth fin and a sixth fin, that extends therefrom.

In some embodiments, the apparatus includes a fan or heat exchanger disposed at a terminal end of at least one of the casing members.

In another aspect, a method (e.g., fabricating a transformer) is disclosed comprising providing a magnetic core having (i) a first arm and a second arm and (ii) a first conductor that wraps around the first arm of the magnetic core and a second conductor that wraps around the second arm of the magnetic core; and fabricating (e.g., via an additive manufacturing process or process employing additive manufacturing process for a mold) a casing structure comprising a dielectric or insulating material configured to surround the first conductor and the second conductor, the casing structure having (i) a first casing member that is placed in proximity to the first arm of the magnetic core and (ii) a second casing member that is placed in proximity to the second arm of the magnetic core, wherein at least one of the first casing member or the second casing member includes a set of finned structures, including a first fin and a second fin, that extends therefrom.

In some embodiments, the method includes fabricating (e.g., via an additive manufacturing process or a process employing an additive manufacturing process to generate a mold) the first fin and second fin, each having a cooling surface that extends along a portion of the first casing member (e.g., in a parallel or non-angled configuration of the first arm).

In some embodiments, the method includes fabricating (e.g., via additive manufacturing process or process employing additive manufacturing process for a mold) the set of finned structures each having a cooling surface that extends along a portion of the first casing member (e.g., in a parallel or angled configuration to the first arm) to form a set of cooling channels.

In some embodiments, the method includes fabricating the first fin and second fin, each having the cooling surface that extends along the portion of the first casing member in a parallel configuration to the first arm or a non-parallel configuration to the first arm.

In some embodiments, the casing structure is fabricated by an additive manufacturing process.

In some embodiments, the casing structure is fabricated using a mold formed by an additive manufacturing process.

In some embodiments, the method includes fabricating (e.g., via an additive manufacturing process or process employing additive manufacturing process for a mold) a third casing member (e.g., inner casing structure for the first arm) that is placed in proximity to the first arm of the magnetic core and in between the first arm and the first conductor and fabricating (e.g., via an additive manufacturing process or process employing additive manufacturing process for a mold) a fourth casing member (e.g., inner casing structure for the second arm) that is placed in proximity to the second arm of the magnetic core and in between the second arm and the second conductor, wherein at least one of the third casing member or the fourth casing member includes a second set of finned structures, including a third fin and a fourth fin, that extends therefrom.

In some embodiments, the method includes fabricating (e.g., via an additive manufacturing process or process employing additive manufacturing process for a mold) the third casing member and the fourth casing member to form a second casing structure, the second casing structure having an air gap in between the third casing member and the fourth casing member.

In some embodiments, the method includes fabricating (e.g., via an additive manufacturing process or process employing additive manufacturing process for a mold) the third casing member and the fourth casing member to form a second casing structure, the second casing structure having a dielectric material in between the third casing member and the fourth casing member.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF DRAWINGS

FIG. 1 shows an exemplary high insulation transformer configured with a finned internal and external casing structure in accordance with an illustrative embodiment.

FIGS. 2A-2B show an example of the finned case structure.

FIGS. 3A-3D depict various configurations of finned bobbin structures.

FIG. 3E depicts various configurations and geometries of the magnetic core.

FIGS. 3F-3I depict various configurations and geometries of fins.

FIG. 4 shows a flowchart depicting a method of the present disclosure (e.g., a method of fabricating the transformer shown in FIG. 1).

FIG. 5A depicts a side view of an insulation structure showing components therein, according to another implementation.

FIG. 5B depicts an example bobbin structure and fin performance showing a simplified top view of the bobbin structure with zoom in nominal flat bobbin surface and integrated fin bobbin surface as well as a parametric fin performance model, where a is half fin thickness, b is half gap, the bobbin temperature between fins is lumped as T1, the bobbin temperature adjacent to the fin is lumped as T2, T_{w} denotes winding temperature.

FIG. 5C shows an assembled medium-voltage (MV) dual active bridge (DAB) SST (also referred to herein as DABSST) with the developed MFT prototype with a corresponding circuit diagram.

FIG. 5D depicts the recorded temperature rise curve of the windings with thermocouples during thermal test.

FIG. 5E depicts a thermal camera image of the MFT steady-state temperature field with equivalent losses at 100 kW output power.

FIG. 6A shows a plot showing the effect of encapsulant thermal conductivity on hotspot temperature.

FIG. 6B depicts the effect of air channel height on maximum electric filed under 20 kV AC peak voltage.

FIGS. 7A-7E show simulation results of a 3-D FEM thermal MFT simulation model with forced air-cooling.

FIGS. 8A-8F show electrical and magnetic simulations of the MFT simulation moidel. FIG. 8A shows a plot of MFT prototype winding AC resistance over varied frequencies. FIG. 8B shows a 3D plot showing core loss versus frequency f and flux density B for two cores. FIGS. 8C and 8D show Maxwell 2-D electrostatic simulation under applied voltage of 20 kV where FIG. 8C shows the electric field of windings without potting and FIG. 8D shows the electric field of potted windings. Note that the color scales are different in these two plots. FIG. 8E shows 60 Hz sinusoidal waveform PD test platform. FIG. 8F shows phase-resolved PD pattern diagram at 60 Hz 20 kV ac peak voltage.

The components in the drawings are not necessarily to scale relative to each other. Like reference, numerals designate corresponding parts throughout the several views.

### DETAILED DESCRIPTION

It is appreciated that certain features of the disclosure, which are, for clarity, described in the context of separate aspects, can also be provided in combination with a single aspect. Conversely, various features of the disclosure, which are, for brevity, described in the context of a single aspect, can also be provided separately or in any suitable subcombination. Unless defined otherwise, all technical and scientific terms used herein have the same meaning as commonly understood by one of ordinary skill in the art. Methods and materials similar or equivalent to those described herein can be used in the practice or testing of the present disclosure.

### Example System

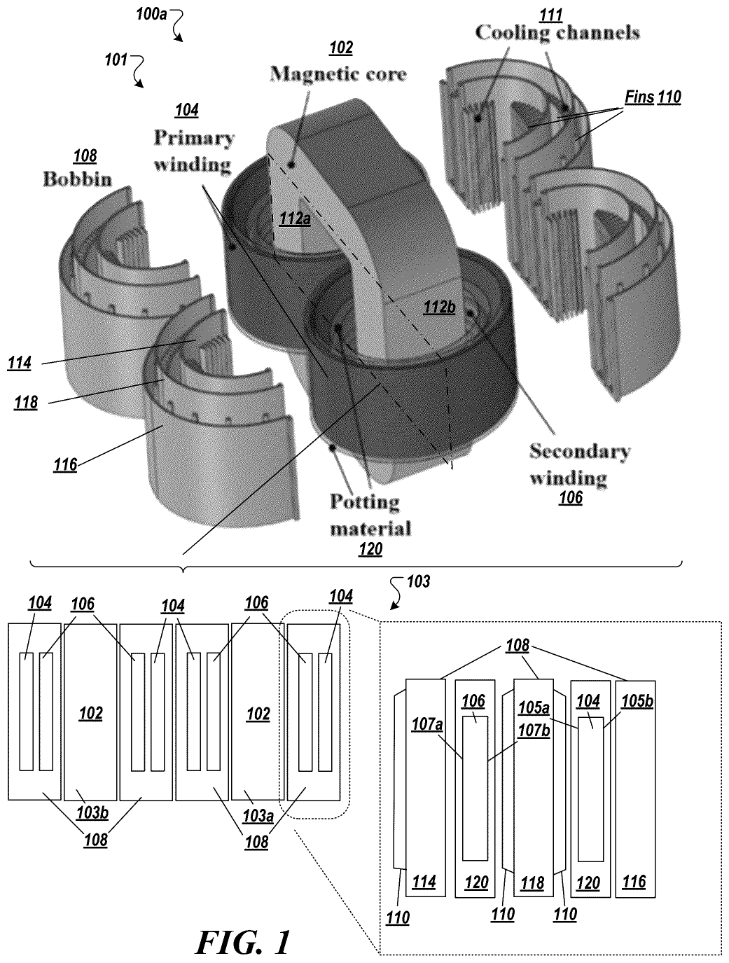

FIG. 1 shows an exemplary high insulation transformer 100 (shown as 100a) configured with a finned internal and external casing structure in accordance with an illustrative embodiment. In the example of FIG. 1, the exemplary transformer 100a includes a magnetic core 102, a first conductor 104 (shown as “Primary Winding” 104), a second conductor 106 (shown as “Secondary Winding” 106), and a casing structure 108 (shown as “Bobbin”) having fins 110.

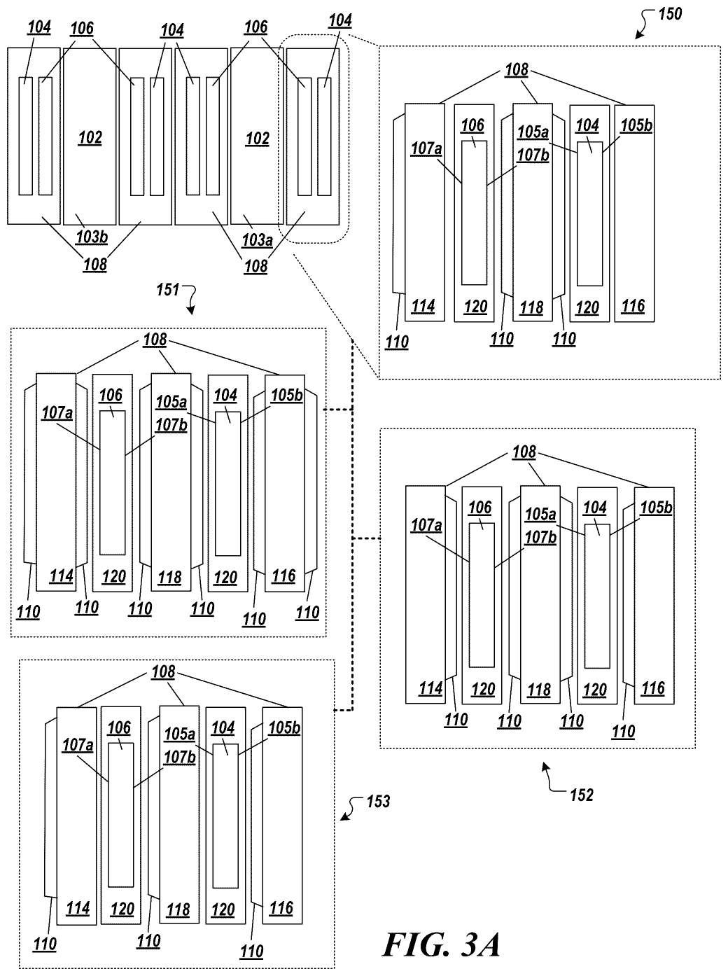

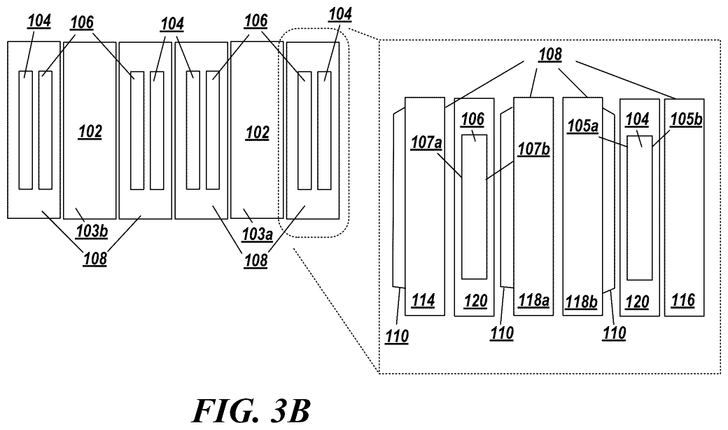

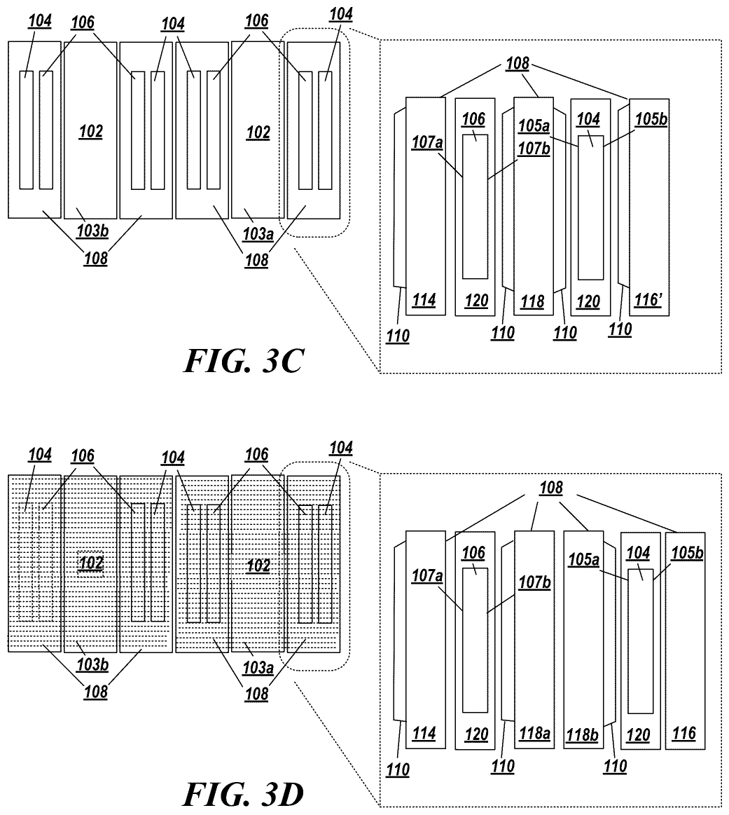

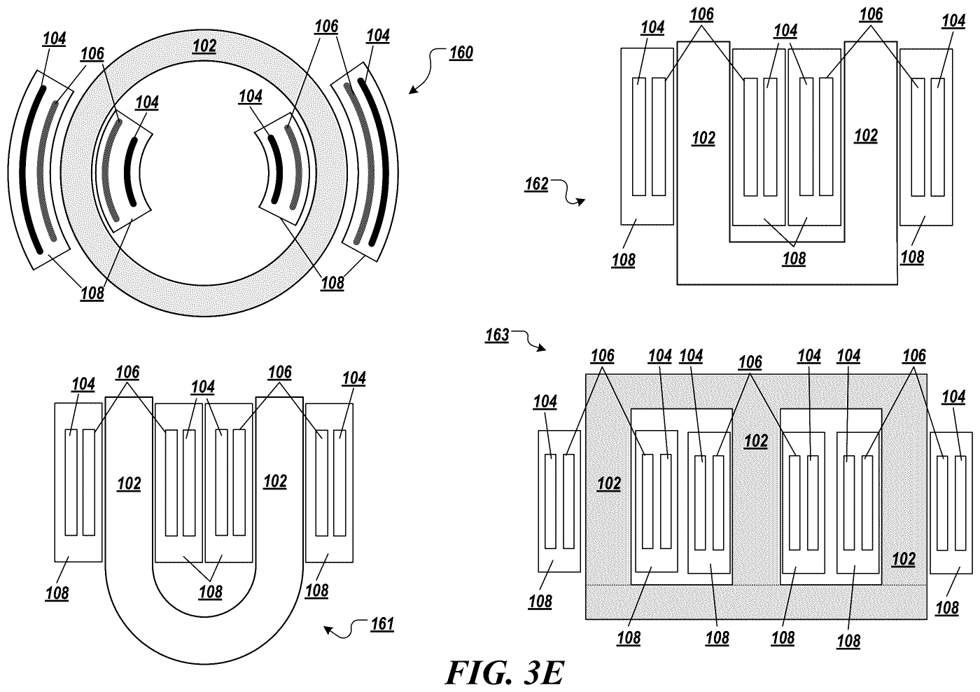

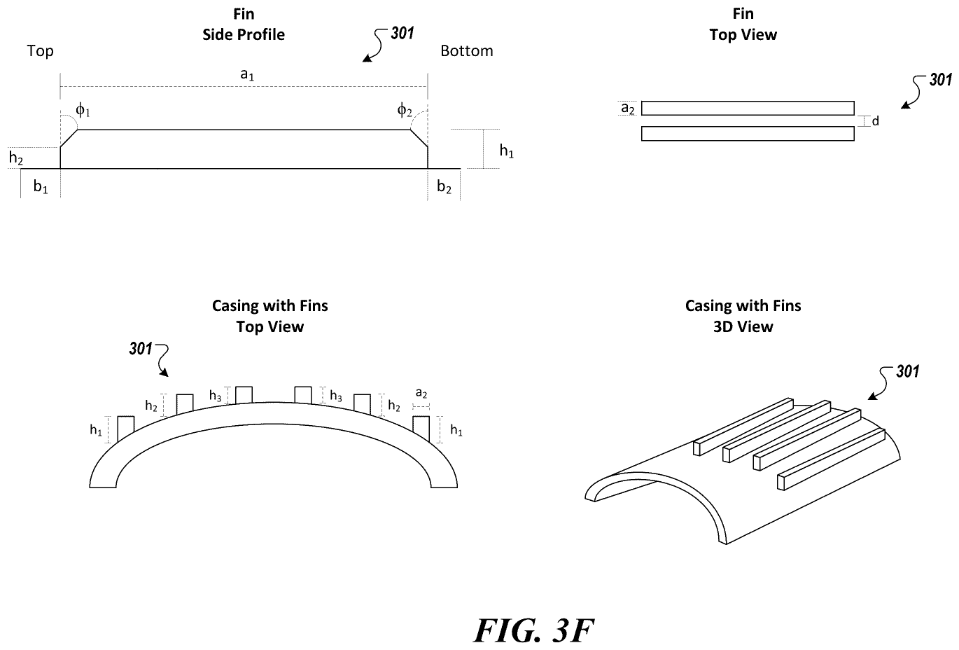

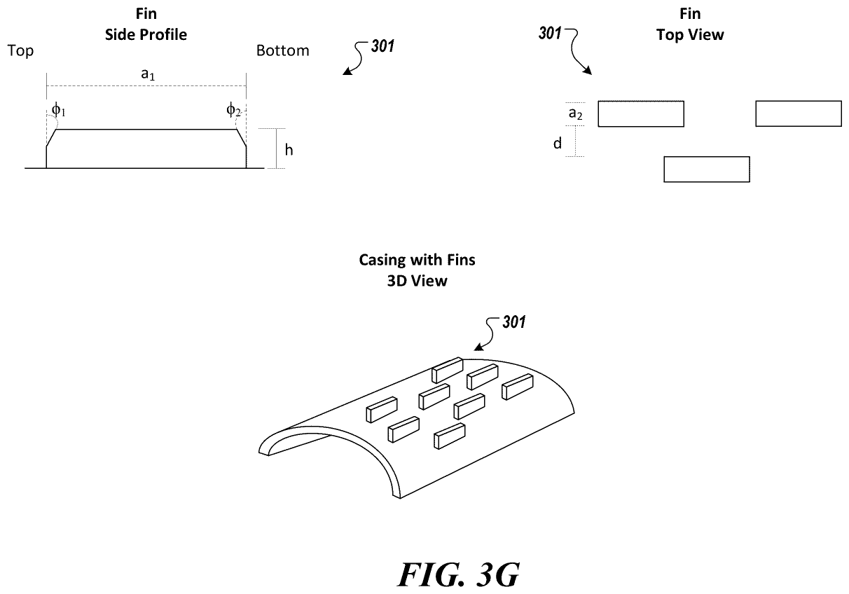

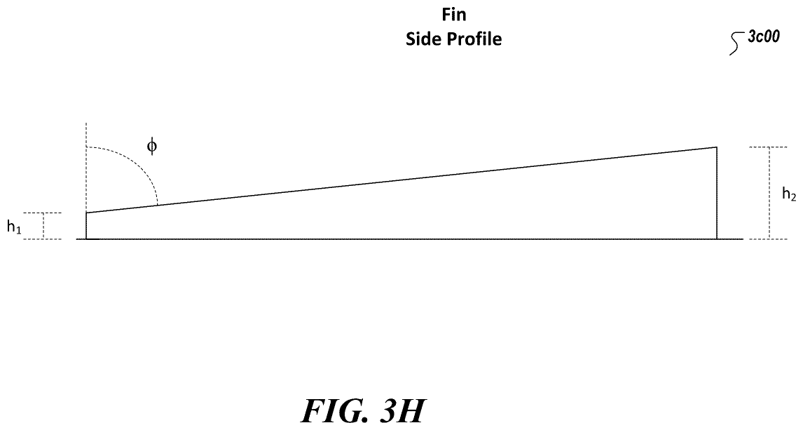

The magnetic core 102 includes a magnetic structure having a first arm 112a and a second arm 112b connected together in an “O” configuration (shown in diagram 101). The magnetic structure can be fabricated as a unitary structure or in parts, e.g., as plates. For example, see FIG. 3E showing various configurations of the magnetic core of the present disclosure. The magnetic core 102 couples to the first conductor 104 and the second conductor 106 at each of the first arm 112a and the second arm 112b. By varying the currents generated by the first conductor 104, a varying magnetic flux can form in and around the magnetic core 102 that induces a varying electromagnetic force at the second conductor 106 per Lenz's Law that can induce an electric current, or vice versa. Heat is then generated as a resistive loss of the core and conductors. The magnetic core 102 also has high magnetic permeability so that the magnetic flux passes through both the first and second conductors 104, 106. Eddy currents, and eddy current losses, and other parasitic losses, are also generated as the magnetic flux passes through the first and second conductors 104, 106 that generate heat in the core 102 and nearby structures, in particular, at the first and second conductors 104, 106 and at an inner, outer, and intermediate casing 114, 116, 118 of the casing structures 108.

In the example shown in FIG. 1, a cross-sectional view 103 is provided for the first conductor 104 (made of a conductive material) winds around the second conductor 106 (same or different conductive material) that coils around, or placed in proximity to, the respective first arm 112a and the second arm 112b of the magnetic core 106. In the example shown in FIG. 1, the first conductor 104 and the second conductor 106 are shown embedded within a potting material 120 (e.g., abrasive epoxy resins or polyurethane encapsulating adhesive, among others) that aid in the insulation of the conductors. The first conductor 104 includes an inner surface 105a and an outer surface 105b, and the second conductor 106 includes an inner surface 107a and an outer surface 107b.

The casing structures 108 are configured, as a bobbin, to support the windings 104, 106 and align it with respect to the transformer core 102 and the connection terminals (not shown). To facilitate heat removal and/or the thermal regulation of the casing structures 108, the structures 108 are configured to include a set of fins 110. In the example shown in FIG. 1, the set of fins 110 is shown arranged to form cooling channels 111. The fins 110 can be in other configurations, geometric topology, and configurations as described herein, among others.

In the example shown in FIG. 1, the casing structures 108 include an inner, outer, and intermediate casing 114, 116, 118. In the example shown in FIG. 1, a set of fins 110 is disposed radially inward from the inner casing 114 adjacent the first conductor 104. Furthermore, the inner casing 114 and the intermediate casing 118 includes a set of fins 110 therebetween. Furthermore, the intermediate casing 118 and the outer casing 116 includes a set of fins 110 therebetween.

As shown in the example of FIG. 1, at least one set of fins 110 protrudes, along a radial direction toward the core 102, from one or more the casing structures 114, 116, 118 and is made of a dielectric or insulating material. The set of fins 110 increases the surface area of the casing structures 114, 116, 118 to improve heat distribution throughout the casing structure while heat is generated at the magnetic core 102 and nearby structures. The set of fins 110 functions to increase the surface area of the casing structure 108 and improve thermal regulation and heat removal. The set of fins 110 increases the surface area of the casing member 108 and allows for improved heat transfer between a dielectric or insulative material and air. As shown in FIG. 1, the set of fins 114 creates a series of cooling channels 111 along the outer and inner casing members 110, 112 to facilitate ameliorated heat transfer, granting improved thermal regulation and heat removal to the system.

### Example Finned Bobbin Structures

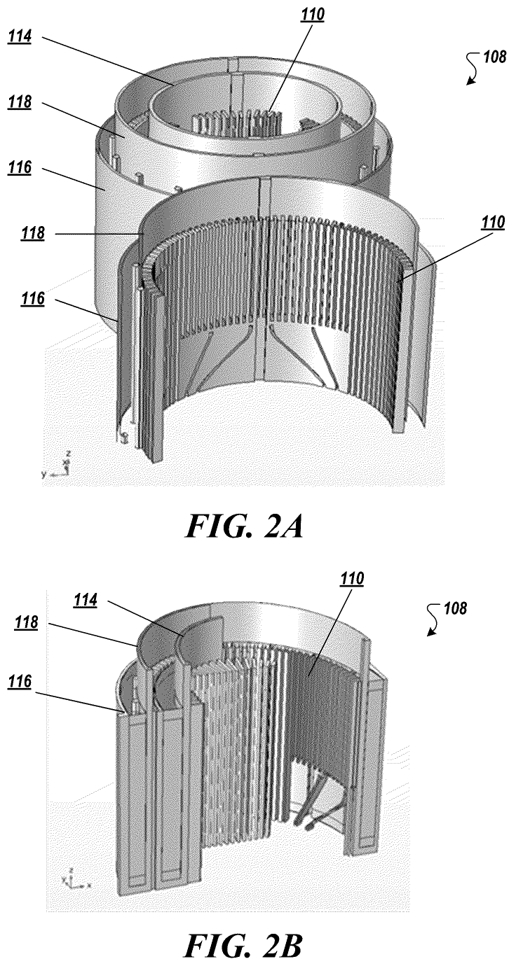

FIGS. 2A-2B show an example of the finned case structure 108 including the inner, outer, and intermediate casing 114, 116, 118 and the corresponding fins 110. FIG. 2A shows a model of a finned casing structure 108 with one half of a finned casing structure 108 in the foreground with the outer casing 116 and the intermediate casing 118. The pattern of fins 110 defining the corresponding cooling channels is visible on the inner surface of the intermediate casing 118. Furthermore, FIG. 2B shows a model of one half of a finned casing structure 108 including a portion of the inner casing 114. The larger fins 110 are visible on the inner surface of the inner casing 114. While FIGS. 2A-2B each depict models of the finned casing structure of the present disclosure, they are illustrative examples only, and different patterns, structure, and geometry are contemplated for alternative embodiments.

### Example Fin Designs

FIGS. 3A-3F show additional examples of the finned case structure 114, 116, 118. FIGS. 3A-3F show similar cross-sectional view of a portion of the finned transformer. Specifically, FIG. 3A shows the finned case structure 114, 116, 118 in FIG. 1 in three distinct layers in which the inner casing 114 and intermediate casing 118 include fins 110. Though shown with gaps in the figures, the finned case structure 114, 116, 118 can be dimensioned to be in direct and thermal contact with nearby structures, e.g., conductors 104, 106 and associated potting 120. Specifically, FIG. 3A includes a diagram showing the case structure configuration 150. In the case structure 150, the outer casing 116 includes no fins, the intermediate casing 118 includes fins 110 that extend on both sides toward the second conductor 106 and the first conductor 104, and the inner casing 114 includes fins that extend inwardly away from the second conductor 106.

It is understood that various configurations of the casing structure 108 are contemplated by this disclosure. FIG. 3A further includes three more example configurations of the casing structure as optional configurations in place of the case structure 150. For example, case structure 151 includes fins extending from all sides of all casing layers. That is, in the casing structure 151, (i) the outer casing 116 includes fins 110 that extend on both sides towards the first conductor 104 and outwardly away from the first conductor, (ii) the intermediate casing 118 includes fins 110 that extend on both sides toward the second conductor 106 and the first conductor 104, and (iii) the inner casing 114 includes fins that extend on both sides toward the second conductor 106 and inwardly away from the second conductor 106.

As another option, FIG. 3A includes a case structure 152 having conductor-facing fins only. For example, in the case structure 152 (i) the outer casing 116 includes fins sthat extend on the side towards the first conductor 104, (ii) the intermediate casing 118 includes fins 110 that extend on both sides toward the second conductor 106 and the first conductor 104, and (iii) the inner casing 114 includes fins that extend on the side towards the second conductor 106.

As another option, FIG. 3A includes a case structure 153 having inward-facing fins only. For example, in the case structure 153 (i) the outer casing 116 includes fins sthat extend on the side towards the first conductor 104, (ii) the intermediate casing 118 includes fins 110 that extend on the side towards the second conductor 106, and (iii) the inner casing 114 includes fins extending on the inwardly away from the second conductor 106.

FIG. 3B shows another configuration of the finned case structure 114, 116, 118 of FIG. 1 in which the intermediate casing structure 118 (shown as 118a, 118b) includes two layers that are connected to one another and form a cooling gap.

FIG. 3C shows another configuration of the finned case structure 114, 116, 118 of FIG. 1 in which the outer casing structure 116 (shown as 116′) includes fins 110 that extend towards the first conductor 104 and associated potting 120. Again, as explained with reference to FIG. 3A, a variety of configurations of fin structures are contemplated by the instant disclosure, including those with inward-facing, outward-facing, and/or conductor-facing fins, that may be deployed for different heat dissipation scenario.

FIG. 3D shows another configuration of the finned case structure 114, 116, 118 of FIG. 1 in which components are fabricated as plates that are stacked to form the case structure. As elsewhere described, the magnetic core 102 includes a magnetic structure having a first arm 112a and a second arm 112b connected together in a rounded square or an “O” configuration (shown in diagram 101). The structure of the magnetic core may take a variety of shaps depending on the usage and/or the manufacturing scheme. For example, the magnetic structure can be fabricated as a unitary structure or in parts, e.g., as plates, which may affect the overall geometory of the magnetic core.

FIG. 3E shows a device 160 with a magnetic core 120 that is functionally similar to the magnetic core 102 of device 100a of FIG. 1. Each of the casing structures 108 with the first and second windings (i.e., the first conductor 104 and the second conductor 106) wrap around opposing sides of the magnetic core 120 of device 160. The casing structures and the corresponding first and second conductors 104, 106 may be wedge- or arc-shaped to match the curvature of the circular magnetic core 160.

FIG. 3E further shows a device 161 with a rounded U-shaped magnetic core 120 and another device 162 with a squared U-shaped magnetic core 120. Each of the rounded U-shaped magnetic core and the squared U-shaped magnetic core of devices 161, 162 is functionally similar to the magnetic core 102 of device 100a of FIG. 1. In the example shown in FIG. 3E, each of the casing structures 108 with the first and second windings (i.e., the first conductor 104 and the second conductor 106) wrap around opposing sides of the U-shaped magnetic core 161, 162.

FIG. 3E further shows a device 163 with a figure-eight-shaped magnetic core 120, which may be formed from an E-shaped portion coupled to an enlongated portion. The magnetic core 120 of the device 163 includes sets of windings (i.e., the first conductor 104, and the second conductor 106) that are surrounded by three sets of the casing structure 108. Each side of the magnetic core 120 of device 163 may have a differently oriented electric field (e.g., clockwise on the left loop and counterclockwise on the right loop). Other configurations of sets of windings and corresponding electric field directions are contemplated by this disclosure.

FIGS. 3F-3I provide various implementations of fin designs, geometry, and topology (e.g., for the fins 110 of the exemplary high insulation transformer 100 of FIG. 1).

FIG. 3F shows an embodiment of a fin 301 similar in material and function as the fins 110 shown in FIG. 1, according to one implementation. The fin 301 is shown in a fin side profile view, a fin top view, a casing with fins top view, and a perspective view of a casing with fins 301. The fins 301 in FIG. 3F each extend uniformly along the surface of a casing, separately radially by a uniform distance from an adjacent fin.

The fin 301 as depicted in the fin side profile is a structure of height h₁ and length a₁ that may be tapered at either end from a height of h₂ and at an angle of ϕ₁ or ϕ₂. Each fin may be offset from either the top or bottom of a surface of a casing member (e.g., casing members 108 shown in FIG. 1) by a distance of b₁ or b₂.

The fin 301 as depicted in the fin top view is a structure that has a width of a₂ and a distance of d from any adjacent fin 301 and may be uniformly or nonuniformly distributed along the face of the casing member.

The fin 301 as depicted in the casing with fins top view has varying heights of h₁, h₂, and h₃ along the surface of the casing member. The example in the casing top view shows the fins 301 extending uniformly towards a singular, relative direction; however, alternative embodiments may have fins that extend perpendicular or nonuniformly to the surface in which sufficient airflow may allow for improved thermal regulation and heat distribution along the embodiment.

The fins 301 as depicted in the 3D view shows an arrangement of fins along the surface of the casing member. The distribution of the fins 301 may be uniformly or nonuniformly placed to provide improved thermal regulation and heat distribution for the embodiment.

FIG. 3G shows an alternative embodiment of the fins 301, similar to that of FIG. 3F. However, the fins 301 in FIG. 3G are discrete fins spaced apart longitudinally as well as radially from an adjacent fin. The fins 301 in FIG. 3G alternate in a pattern along the length of the surface of the casing as well as radially around the surface.

FIG. 3H shows an alternative embodiment of a fin of this disclosure wherein the fin includes a tapered surface from one end to the other. For example, the fin may have a first height h₁ on a first side and a second height h₂ on a second side that is taller than the first height. The first side of the fin may be oriented on a first side of a casing of an exemplary high insulation transformer.

FIG. 3I shows another alternative embodiment of a fin of this disclosure wherein the fin includes a wavy or contoured profile when viewed from the top side of the fin. For example, the fin may include a curve defined by a plurality of angles ϕ along the length of the fin.

### Method of Fabrication

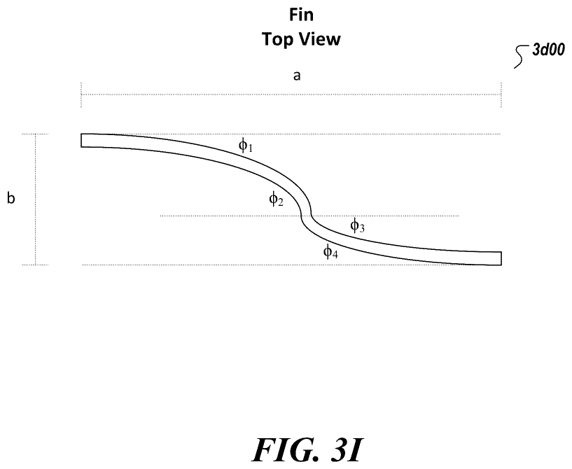

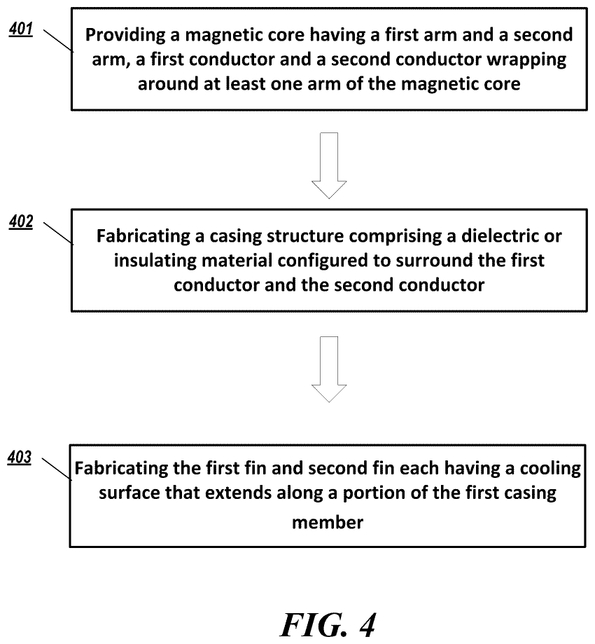

FIG. 4 shows a flowchart depicting a method of the present disclosure (e.g., a method of fabricating the transformer shown in FIG. 1). The method includes, at step 401, providing a magnetic core. For example, the magnetic core has (i) a first arm and a second arm and (ii) a first conductor that wraps around the first arm of the magnetic core and a second conductor that wraps around the first arm of the magnetic core, the first conductor wrapping around the second conductor.

The method further includes, at step 402, fabricating a casing structure comprising a dielectric or insulating material configured to surround the first conductor and the second conductor. For example, the fabricating may be via an additive manufacturing process or process employing additive manufacturing process for a mold. The casing structure may include (i) a first casing member that is placed in proximity to the first arm of the magnetic core and (ii) a second casing member that is placed in proximity to the second arm of the magnetic core, wherein at least one of the first casing member or the second casing member includes a set of finned structures, including a first fin and a second fin, that extends therefrom.

In some implementations, the method of FIG. 4 further includes, at step 403, fabricating the first fin and second fin each having a cooling surface that extends along a portion of the first casing member. For example, the cooling surface may be configured in a parallel or non-angled configuration of the first arm.

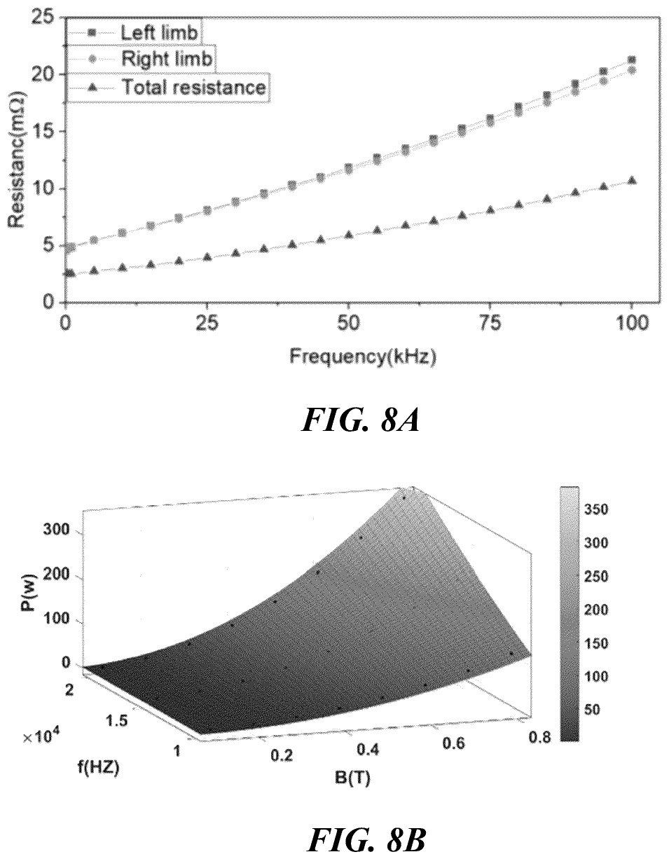

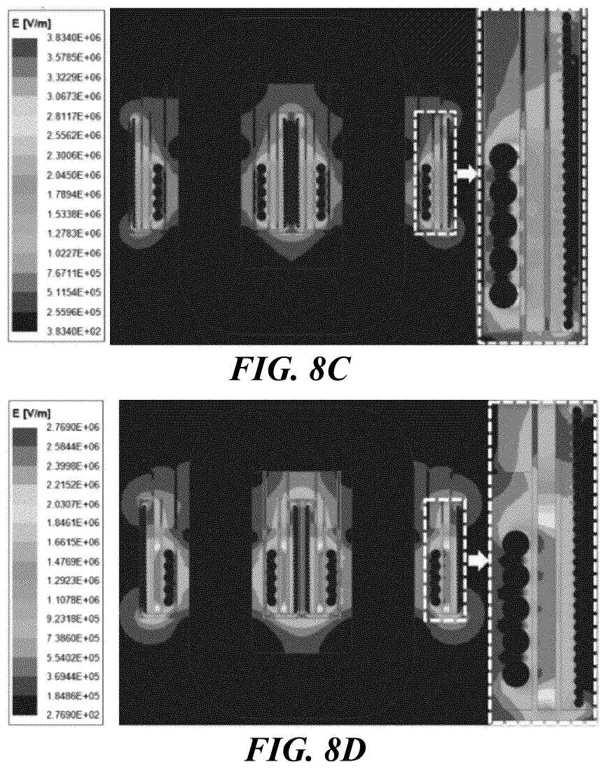

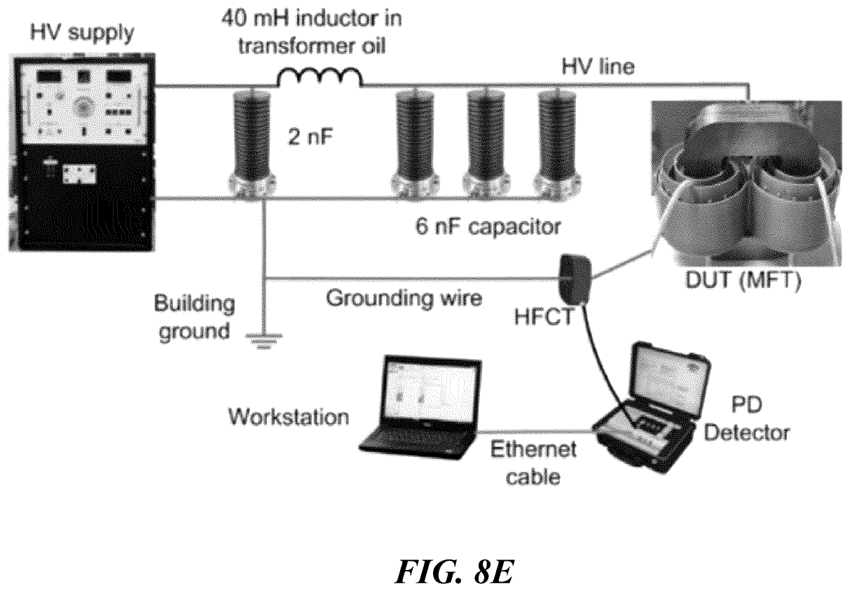

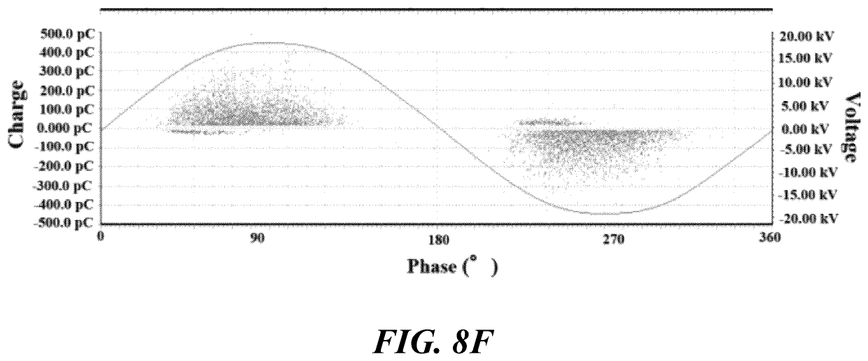

Losses Modeling. MFT winding losses depend on the transformer current and the winding AC resistance. To estimate the frequency-dependent winding losses, accurate AC resistance and the corresponding harmonic current are required. FIG. 8A shows the winding (Litz wire) resistance measurement value using a Hioki IM3536 LCR meter. To calculate winding loss for non-sinusoidal current waveform, fast Fourier transform (FFT) is applied to the current waveform. The total losses can be calculated as the sum of loss at each sine wave frequency [10].

$${P}_{winding} = {\sum }_{n = 1}^{9} {{I}_{RMS} ( n )}^{2} {R}_{A C} ( n ) \qquad ( 1 )$$

where n is the FFT component index, R_{AC}(n) is the winding resistance at the nth frequency range, I_{RMS}(n) is the current component at the nth frequency range, which is equals to FFT_{magnitude}(n)/√2. The number of harmonics is up to 9 due to the ignorable current at higher order.

Based on the core loss density data from 10 to 20 kHz, a 3-D curve of core loss versus frequency f and flux density B can be visualized in FIG. 8B. For non-sinusoidal magnetization cases, the improved generalized Steinmetz equation is applied within this design methodology to obtain the magnetic specific core loss.

$${P}_{v} = \frac{1}{T} {\int }_{0}^{T} {k}_{i} {\vert \frac{d B ( t )}{dt} \vert}^{α} {( Δ B )}^{β - α} dt \qquad ( 2 )$$

$${k}_{i} = \frac{K}{{( 2 π )}^{α - 1} {\int }_{0}^{2 π} {\vert cos θ \vert}^{{α}_{2} β - α} d θ} \qquad ( 3 )$$

where K, α, and β are determined by the magnetic core characteristics, f is the frequency of the excitation waveform and ΔB is the peak-to-peak magnetic induction.

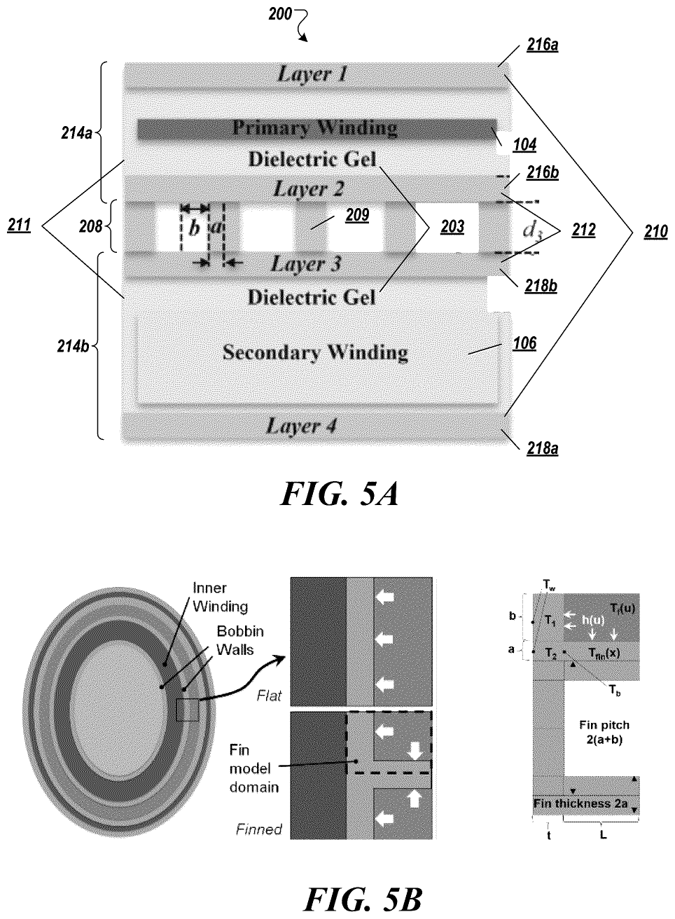

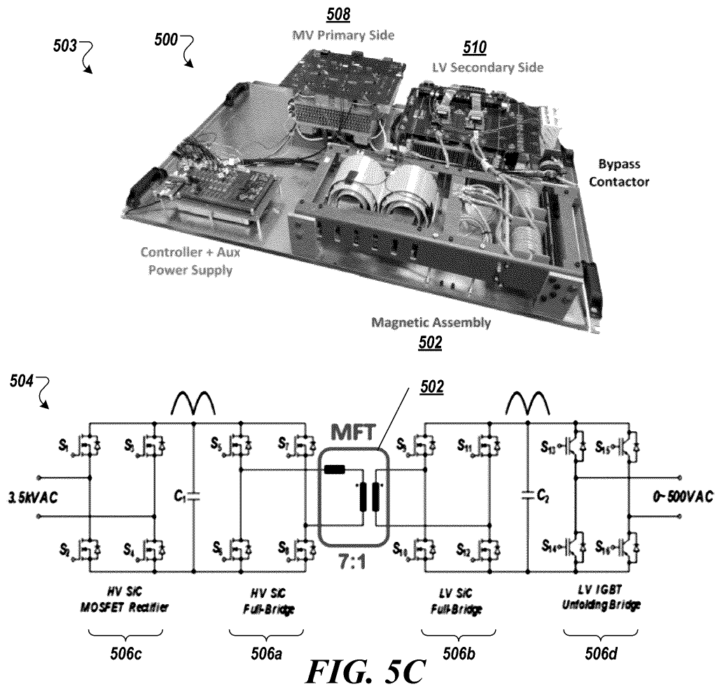

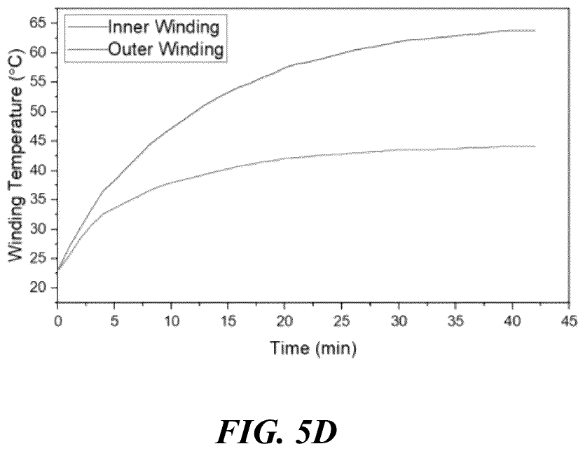

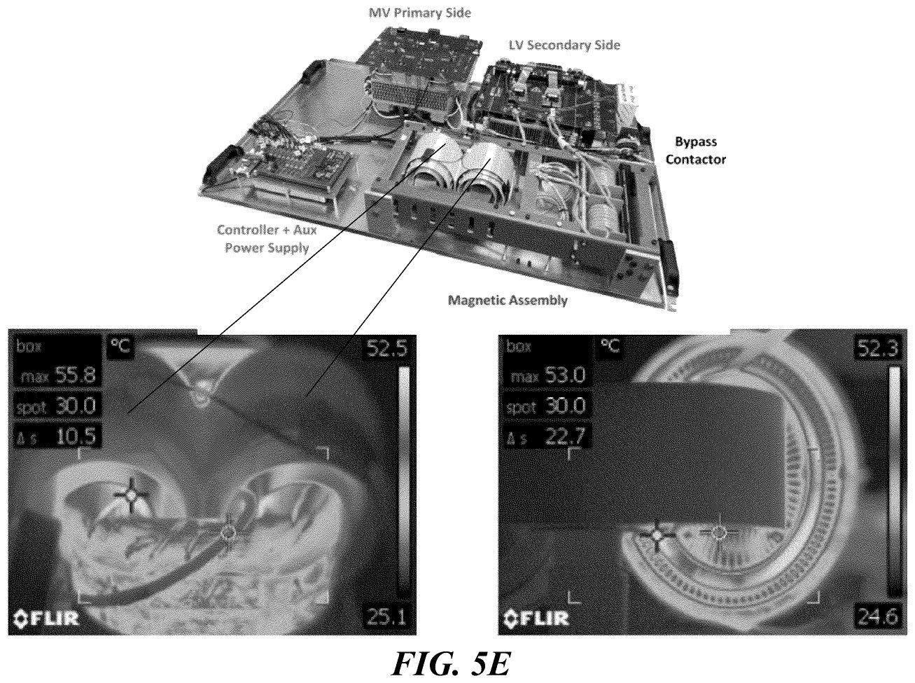

Example Insulation System Design. Considering the well-coupled winding structure and fixed magnetic core dimensions, an insulation structure is proposed to achieve good insulation. The 3-D printed bobbin provides the housing for primary windings, secondary windings, and air channels. FIG. 5A shows the insulation structure: layers 1 and 2 form the primary windings housing, layers 2 and 3 form air channels, and layers 3 and 4 form secondary windings housing. All the windings are potted with dielectric gel to achieve higher insulation voltage.

FIG. 5A is a side view of the insulation structure 200 between the first conductor 104 (shown as “Primary Winding” 104) and the second conductor 106 (as shown as “Secondary Winding”). In the example of FIG. 5A, the first conductor 104 and the secondary conductor 106 are embedded in a potting material 203 (shown as “Dielectric Gel” 204). The insulation structure 200 includes a casing assembly 208 and a set of fins 209. The potting material 203, the primary conductor 104, and the secondary conductor 106 comprise a similar material and function as the potting material 120, the primary conductor 104, and the secondary conductor 106 in FIG. 1.

The set of fins 209 functions similar to the set of fins 114 in FIG. 1 by increasing the surface area of insulation structure 200 to allow for improved thermal regulation and heat distribution. In the example in FIG. 5A, the air gaps created by the set of fins 209 allow for increased heat transfer to occur from the insulating structure 200 when heat is generated by the conductors 104, 106. Additionally, connection created by the set of fins 209 improves the heat transfer of either section 214a, 214b along the air gap, enabling an ameliorated thermal regulation.

FIG. 5B displays (a) Simplified top view of bobbin structure with zoom in nominal flat bobbin surface and integrated fin bobbin surface, and (b) Parametric fin performance model, where a is half fin thickness, b is half gap, the bobbin temperature between fins is lumped as T1, the bobbin temperature adjacent to the fin is lumped as T2, Tw denotes winding temperature.

When the primary winding is applied with a 20 kV AC peak voltage, the presence of the potting reduces the maximum E field from 3.83 to 2.77 kV/mm, as shown in FIGS. 8C and 8D. The location of the maximum electric field also shifts from the top and bottom of the windings to the vertical air channels adjacent to the windings. The PDIV of the MFT increases from 14 kV peak voltage to 20 kV peak voltage. PDIV is measured in the 60 Hz PD test platform shown in FIG. 8E. Considering the air breakdown field (PD inception field) is around 2.5-3 kV/mm, the test results match the FEA simulation very well. The electric field distribution under bipolar PWM excitation can be estimated by the boundary condition for the normal field component across a medium interface

$$U = {d}_{1} {E}_{sec \_ gel} + {d}_{2} {E}_{l a yer 2} + {d}_{3} {E}_{a i r} + {d}_{4} {E}_{l a yer 3} + {d}_{5} {E}_{pri \_ gel} \qquad ( 4 )$$

where U is voltage between primary and secondary winding, E_{sec_gel} and d₁ are the electric field and thickness of secondary winding dielectric gel, E_{layer2} and d₂ are the electric field and thickness of the layer 2 bobbin, Eₐᵢᵣ and d₃ are the electric field and thickness of the air channel, E_{layer3} and d₄ are the electric field and thickness of the layer 3, E_{pri_gel} and d₅ are the electric field and thickness of the primary winding dielectric gel. Under bipolar PWM excitation, the boundary condition for the normal field component across a medium interface is shown as follows:

$${ϵ}_{g e l} {E}_{sec \_ gel} = {ϵ}_{P E E K} {E}_{l a yer 2} \qquad ( 5 )$$

$${ϵ}_{P E E K} {E}_{l a yer 2} = {ϵ}_{a i r} {E}_{a i r} \qquad ( 6 )$$

$${ϵ}_{a i r} {E}_{a i r} = {ϵ}_{P E E K} {E}_{l a yer 3} \qquad ( 7 )$$

$${ϵ}_{P E E K} {E}_{l a yer 3} = {ϵ}_{g e l} {E}_{pri \_ gel} \qquad ( 8 )$$

where ϵₐᵢᵣ and ϵ_{PEEK} are the dielectric constants of air and 3-D bobbin material PEEK, and ϵ_{gel} is the dielectric constant of the dielectric gel. The main parameters of insulation materials used in the design are given in Tables I and II.

TABLE I
3-D Printed Filament Candidates

| | Glass Transition | Dielectric | | Thermal |
|---|---|---|---|---|
| | Temperature* - | Stregth @ 25° C. | Dielectric | Conductivity |
| Material | Tg (° C.) | (kV/mm) | Constant | (W/mK) |
| PLA | 60-65 | 13.4 | 3.1 | 0.13 |
| ABS | 105 | 16.7 | 2.87 | 0.17 |
| PEEK | 143 | 23 | 3 | 0.29 |

*The temperature where the material begins to lose the ability to hold its shape

TABLE II
Potting Material Candidates

| | | Dielectric | | | |
|---|---|---|---|---|---|
| | | Stregth @ | | Thermal | Pot |
| | Viscosity | 25° C. | Dielectric | Conductivity | Life |
| Material | (mPa · s) | (kV/mm) | Constant | (W/mK) | (min) |
| CoolTherm ® | 3600 | 23.6 | 4 | 1 | 30 |
| SC-309 | | | | | |
| DOWSIL ™ | 2850 | 33 | 2.7 | 0.66 | 120 |
| CN-8760 | | | | | |
| WACKER | 1000 | 23 | 2.8 | 0.2 | 150 |
| SilGel ® 612 | | | | | |

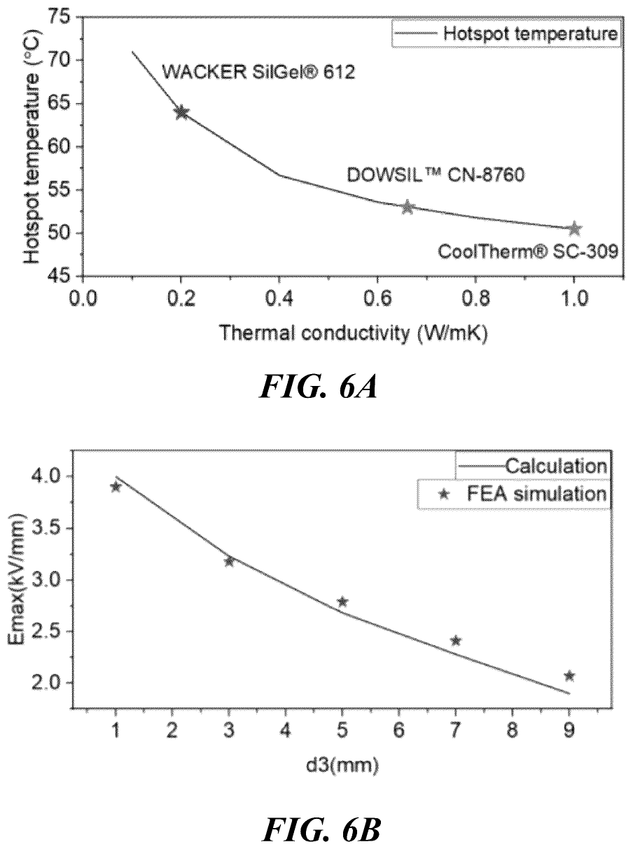

The air channel height is selected based on the theoretical calculation and FEA simulation to make sure the electric field is below the air breakdown value, as shown in FIG. 6B.

The materials for 3-D printed bobbin and potting need to be selected based on dielectric properties (high dielectric strength/low dielectric constant), thermal properties (high thermal conductivity/high glass transition temperature), and potting performance (low viscosity/long pot life). Three commonly used 3-D printing materials are given in Table I. Polyether ether ketone (PEEK) filament is particularly suitable. Exceptional mechanical, thermal, and electric properties make this an ideal material for this application. For potting the windings, insulation oil has desirable properties, but the proposed bobbin structure is not suitable for holding liquid for long time which was only used in the insulation test to verify the design. Table II gives three potential options for the winding potting. SilGel 612 was selected due to the low viscosity, long pot life which helps to remove air bobbles during the vacuum fabrication process.

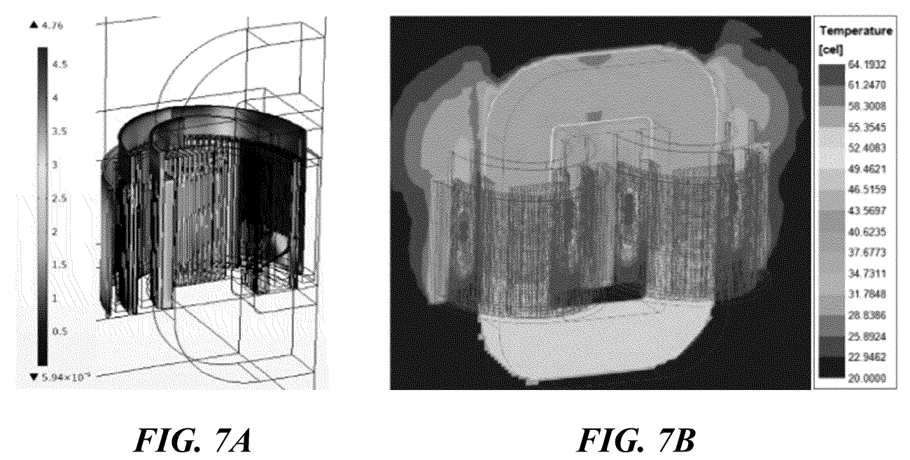

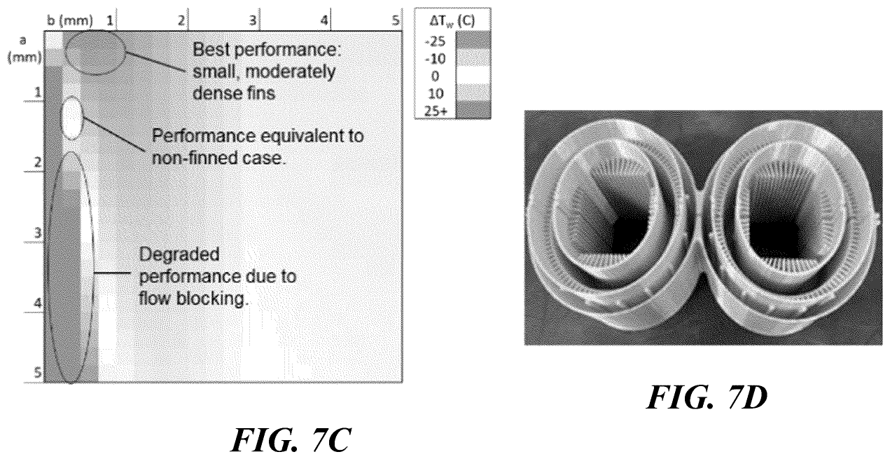

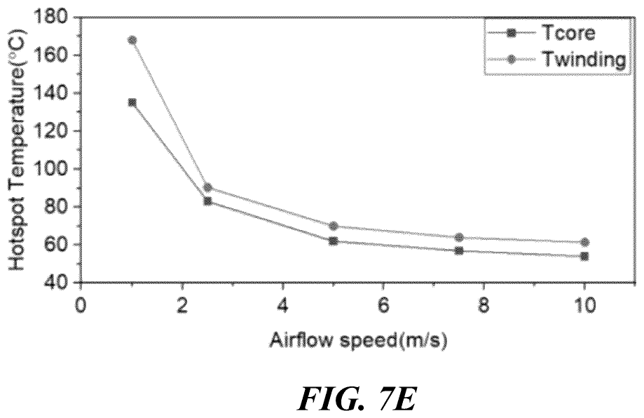

Cooling System Design. To facilitate heat dissipation, integrated fin structures are 3-D printed directly into the bobbin to improve the MFT thermal performance. Forced convection is present on the exposed lower and upper arms of the core, the internal air channels, and the outermost bobbin surface. The concept of heatsink fins is utilized in the bobbin air channel design, and the thickness of each fin and the spacing of the fins are optimized based on parametric model in FIG. 5B. For simplicity, a section of bobbin between fins is lumped as T1, a section adjacent to the fin is lumped as T2, and the fin itself is considered as an ideal 1-D fin with constant convection coefficient and convective tip, with known analytical temperature profile. A finite-difference numerical study on lateral temperature gradient confirmed the validity of the 1-D assumption of the fin for the geometry ranges considered. A parametric model is created with the half-thickness, a, and half-gap, b, as the varying parameters. The benefit of the fins is illustrated by comparing the winding temperature reduction ΔT_{w} with a no-fins design as a baseline. Using an empirical correlation model, a map of predicted ΔT_{w} versus fin dimensions a (half-thickness) and b (half-gap) is shown in FIG. 7C. The best performing fins of those modeled are 0.5 mm thickness with 1.5 mm gap, achieving a 26° C. temperature reduction. FIG. 7D shows the 3-D printed bobbin with PEEK material. Due to 3-D printing limitations and the structural integrity required, the fins of the protype bobbin are 1.5 mm thick with a 2 mm gap. FEA is used to provide detailed and precise thermal modeling.

FIG. 7A shows a 3-D FEM thermal MFT simulation with inlet 7.5 m/s providing forced air-cooling depicting the airflow speed passing through the bobbin air channels. FIG. 7B shows a 3-D FEM thermal MFT simulation with an inlet 7.5 m/s providing forced air-cooling depicting MFT temperature distribution. FIG. 7C depicts a map of the geometry of the bobbins and fins, showing the temperature change achieved by fins versus geometry parameters.

In FIG. 7A, the airflow speed passing through the bobbin air channel is shown. The regions with blue represent the low velocity area which is blocked by the magnetic core.

FIG. 7B shows that the MFT hotspots are at the inner windings, especially the low-velocity areas. The core temperature, winding temperature, and potting material surface temperature match well with the experiment results shown in FIG. 5D and FIG. 6A.

FIG. 7E presents a sensitivity analysis of the hotspot temperatures in the core and the windings versus cooling airflow speed. Both core and winding temperatures decrease with the airflow speed, providing a reference for fan selection under different working conditions. FIG. 7F shows the effect of encapsulant.

### Experimental Results and Additional Examples

A study was conducted to develop a 100-kW high insulation voltage medium-frequency transformer (MFT) 102 (shown as 502) with two FINEMET FT-3TL magnetic cores and a parallel-concentric winding structure. The study developed a three-dimensional printed bobbin with heatsink fins and designed, prototyped, and verified by partial discharge (PD) and thermal tests an insulation and cooling structure with potted windings. The MFT 502 achieved a PDIV of 20 kV AC peak, and the temperature rise was below 45° C. at 100 kW with power density of 10.6 kW/L. The MFT was applied in a dual active bridge-based medium voltage solid state transformer (SST), achieving a peak efficiency of 98.2% at 40 kW and 97.5% at 100 kW. The MFT has a 99.735% efficiency with superior thermal performance at 100 kW output power.

FIG. 5C shows a photo of the 100-kW high insulation voltage MFT 502 and a corresponding circuit schematic 504. The assembled DABSST 500 included the transformer 502 (shown as “magnetic assembly” 502), a primary MV module 508 (shown as “MV Primary Side” 508), and a secondary low voltage module 510 (shown as “LV Secondary Side” 510).

As shown in FIG. 5C, the system developed in the study included a medium-voltage (MV) dual active bridge (DAB) SST (also referred to herein as DABSST) (shown as 506a, 506b) as a single stage AC to AC converter. The DABSST is configured to receive an input voltage of 3.5 kV_{AC} and provide an output voltage of 0 to 500 V_{AC}. The selected working frequency of the MFT was optimized to be around 20 kHz based on the efficiency and dimension of the whole system. The DABSST included an input folding bridge 506c, the DAB stage 506a, 506b, and an output unfolding bridge stage 506d. The exemplary MFT 502 provided galvanic isolation with a 7:1 turn ratio. Table III shows the design specification of the exemplary MFT 502.

TABLE III

| Parameter | Value | |
|---|---|---|
| Power Rating | 100 | kW |
| Input/output voltage | 3500 V/500 V | |
| Primary/secondary RMS current | 30 A/210 A | |
| Working frequency (fs) | 20 | kHz |

| | |
|---|---|
| Transformer turn ratio | 7:1 |

The high-power MFT 502 employed two FINEMET FT-3TL magnetic cores and parallel-concentric winding structure. The MFT prototype achieved low leakage inductance (1.67 uH) and low interwinding parasitic capacitance (61 pF). The well coupled windings and uncut core facilitate reduced near-field magnetic emission. The estimated efficiency at 100 kW is 99.735% with 125-W windings loss and 143-W core loss, with power density exceeding 10.6 kW/L.

The study employed a high AC voltage (HV) 60-Hz sinewave voltage to perform the PD test for the developed MFTs based on IEC 60270 [12]. FIG. 8E shows the PD test setup. In FIG. 8E, the PD test setup included a high-frequency current transformer to capture the PD impulse current. A C-L-3C filter was used to remove the noise from the power supply. The test setup conducted both AC and DC PD tests up to 30 kV with a background noise level of 5 pC. FIG. 8F shows a pattern diagram of the PD test at 60 Hz excitation. Over multiple tests, the measured PDIV was observed to be approximately 14 kV rms/20 kV peak.

Thermal Performance. The SST had a peak efficiency of 98.2% at 40 kW and the efficiency at 100 kW was 97.5%. Both thermocouples and thermal cameras were used to monitor the MFT internal and surface temperature. FIG. 5D shows the temperature rise curve of the windings with thermocouples during thermal test. Thermal camera images of the MFT in FIG. 5E shows both magnetic cores and windings have excellent thermal performance with equivalent losses at 100 kW output power.

Results. The study compared performance for electrical insulation, efficiency, power density, and thermal performance of the exemplary finned transformers to other high-power MFTs [5], [6], [7], [8], [9]. Table IV shows the features of the other high-power MFT and its comparison the exemplary transformer. These designs have power rating exceeding 80 kW, and the operating frequency is from 10 and 80 KHz.

TABLE IV

| | Power | | | | Insulation | | Power | Hot Spot |
|---|---|---|---|---|---|---|---|---|
| | Rating | Frequency | | Cooling | Voltage | Efficiency | Density | Temperature |
| | (kW) | (kHz) | Core Material | Method | (kV) | % | (kW/L) | ° C. |
| UT Austin | 200 | 15 | Nanocrystalline | Air | 5.3 kV | 99.84 | 19.23 | 55 |
| 2021 [5] | | | | | (**) | | | |
| SEU | 250 | 10 | Nanocrystalline | Air | 18 kV | 99.76 | 4.9 | 62.6 |
| 2021 [6] | | | | | (**) | | | |
| ETH | 166 | 77.4 | Air-core | Air | >6.36 kV | 99.5 | 7.8 | 106@225 kW |
| 2022 [7] | | 40 | Ferrite | | (*) | 99.7 | 12.2 | >94.2@250 kW |
| KMUST | 80 | 43 | Ferrite | Air | 42 kV | N/A | 21.1 | 102.1 |
| 2022 [8] | | | | | (*) | | | |
| U of A | 100 | 50 | Ferrite | Air | N/A | 99.62 | 17.7 | 106 |
| 2022 [9] | | | | | | | | |
| This | 100 | 20 | Nanocrystalline | Air | 14 kV | 99.73 | 10.6 | 63.9 |
| letter | | | | | (**) | | | |

(*) Applied voltage insulation test.
(**) Partial discharge insulation test.

It can be observed that the exemplary MFT prototype achieved ultrahigh coupling coefficient and low interwinding parasitic capacitance. The electric insulation was verified by experimental tests achieving a partial discharge inception voltage (PDIV) of 14 kV rms/20 kV peak. The temperature rise was below 45° C. at 100 kW with power density of 10.6 kW/L.

The bobbin dimensions, material, and potting material were informed by targeted computational fluid dynamics modeling and electrostatic simulations.

Discussion Ferrite, and nanocrystalline are typical core materials used, air core design [7] is an alternative option if the weight has higher priority than volume. Potting methods [6], [8] are also used to achieve partial discharge (PD) free design. As MFTs are getting more and more compact, thermal management is also very challenging, even if the MFT is extremely efficient. Considering the cost, design complexity, and additional weight, air cooling is usually preferred over liquid cooling.

### Discussion

Medium voltage (MV) solid-state transformers (SSTs) have been widely studied as the next generation technology for many MV applications such as smart distribution systems, traction systems, renewable energy systems and ultrafast EV chargers. High voltage insulation and thermal management are two major challenges in a high-power medium frequency transformer (MFT) design. Many SST solutions are enabled by the availability of MV SiC power devices [1], [2]. Input-series and output-parallel [3] SST topologies and hybrid SSTs [4] have also been studied to expand the SST to higher voltage and higher power applications. Since the SST is an isolated high-power converter, the medium frequency transformer (MFT) needs to process high power and provide high insulation capability. Therefore, technologies to improve the insulation voltage level of the MFT are urgently needed.

Throughout the description and claims of this specification, the word “comprise” and other forms of the word, such as “comprising” and “comprises,” means including but not limited to, and are not intended to exclude, for example, other additives, segments, integers, or steps. Furthermore, it is to be understood that the terms comprise, comprising, and comprises as they relate to various aspects, elements, and features of the disclosed invention also include the more limited aspects of “consisting essentially of” and “consisting of.”

As used herein, the singular forms “a,” “an,” and “the” include plural referents unless the context clearly dictates otherwise. Thus, for example, reference to a “polymer” includes aspects having two or more such polymers unless the context clearly indicates otherwise.

Ranges can be expressed herein as from “about” one particular value and/or to “about” another particular value. When such a range is expressed, another aspect includes from the one particular value and/or to the other particular value. Similarly, when values are expressed as approximations, by use of the antecedent “about,” it will be understood that the particular value forms another aspect. It should be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

For the terms “for example” and “such as,” and grammatical equivalences thereof, the phrase “and without limitation” is understood to follow unless explicitly stated otherwise.

The following patents, applications and publications as listed below and throughout this document are hereby incorporated by reference in their entirety herein.

### REFERENCE LIST #1

[1] L. Zhang, S. Sen, Z. Guo, X. Zhao, A. Q. Huang, and X. Song, “7.2-kV/60-A Austin supermos: An enabling SiC switch technology for medium voltage applications,” in Proc. IEEE Electric Ship Technol. Symp., 2019, pp. 523-529.
[2] X. Song, A. Q. Huang, S. Sen, L. Zhang, P. Liu, and X. Ni, “15-kV/40-A FREEDM supercascode: A cost-effective SiC high-voltage and high-frequency power switch,” IEEE Trans. Ind. Appl., vol. 53, no. 6, pp. 5715-5727 November/December 2017, doi: 10.1109/TIA.2017.2737627.
[3] W. Xu, Z. Guo, A. Vetrivelan, R. Yu, and A. Q. Huang, “Hardware design of a 13.8 kV/3 MVA PV plus storage solid state transformer (PVS-SST),” IEEE J. Emerg. Sel. Topics Power Electron., vol. 10, no. 4, pp. 3571-3586 August 2022.
[4] S. Rajendran, S. Sen, L. Zhang, Z. Guo, Q. Huang, and A. Q. Huang, “500 kVA hybrid solid state transformer (HSST): Design and implementation of the SST,” in Proc. IEEE Energy Convers. Congr. Expo., 2020, pp. 1642-1649.
[5] Z. Guo, R. Yu, W. Xu, X. Feng, and A. Q. Huang, “Design and optimization of a 200-kW medium-frequency transformer for medium-voltage SiC PV inverters,” IEEE Trans. Power Electron., vol. 36, no. 9, pp. 10548-10560, September 2021.
[6] Z. Cao, W. Chen, J. Jiang, K. Zhang, Y. Chen, and Z. Shen, “Design of dry type high-power high-frequency transformer based on triangular closed core,” in Proc. IEEE Sustain. Power Energy Conf., 2021, pp. 3336-3341.
[7] P. Czyz et al., “Analysis of the performance limits of 166 kW/7 kV Air- and Magnetic-Core medium-voltage medium-frequency transformers for 1:1-DCX applications,” IEEE J. Emerg. Sel. Topics Power Electron., vol. 10, no. 3, pp. 2989-312 June 2022.
[8] S. Lu, D. Kong, S. Xu, L. Luo, and S. Li, “A high-efficiency 80-kW split planar transformer for medium-voltage modular power conversion,” IEEE Trans. Power Electron., vol. 37, no. 8, pp. 8762-8766 August 2022.
[9] Z. Zhao, Y. Wu, F. Diao, N. Lin, X. Du, and Y. Zhao, “A high-power, high-frequency matrix core transformer design for medium voltage dual active bridge,” in Proc. IEEE Appl. Power Electron. Conf. Expo., 2022, pp. 582-587, doi: 10.1109/APEC43599.2022.9773400.
[10] W. G. Hurley, E. Gath, and J. G. Breslin, “Optimizing the ac resistance of multilayer transformer windings with arbitrary current waveforms,” IEEE Trans. Power Electron., vol. 15, no. 2, pp. 369-376, March 2000.
[11] K. Venkatachalam, C. R. Sullivan, T. Abdallah, and H. Tacca, “Accurate prediction of ferrite core loss with nonsinusoidal waveforms using only steinmetz parameters,” in Proc. IEEE Workshop Comput. Power Electron., 2002, pp. 36-41.
[12] High-Voltage Test Techniques-Partial Discharge Measurements, IEC 60270:2000, 2000.

What is claimed is:

1. An apparatus comprising:
a magnetic core having a first arm and a second arm;
a first conductor that wraps around the first arm of the magnetic core;
a second conductor that wraps around the first arm of the magnetic core, the first conductor wrapping around the second conductor; and
a casing structure comprising a dielectric or insulating material that surrounds the first conductor and the second conductor, the casing structure having (i) a first casing member that is placed in proximity to the first arm of the magnetic core and (ii) a second casing member that is placed in proximity to the second arm of the magnetic core, wherein at least one of the first casing member or the second casing member includes a set of finned structures, including a first fin and a second fin, that extends therefrom.

2. The apparatus of claim 1, wherein the first fin and second fin each have a cooling surface that extends along a portion of the first casing member.

3. The apparatus of claim 1, wherein the set of finned structures each has a cooling surface that extends along a portion of the first casing member to form a set of cooling channels.

4. The apparatus of claim 2, wherein the first fin and second fin each have the cooling surface that extends along the portion of the first casing member in a parallel configuration to the first arm.

5. The apparatus of claim 2, wherein the first fin and second fin each have the cooling surface that extends along the portion of the first casing member in a non-parallel configuration to the first arm.

6. The apparatus of claim 1 further comprising:
a third casing member that is placed in proximity to the first arm of the magnetic core and in between the first arm and the first and second conductors and
a fourth casing member that is placed in proximity to the second arm of the magnetic core and in between the second arm and the first and second conductors, wherein at least one of the third casing member or the fourth casing member includes a second set of finned structures, including a third fin and a fourth fin, that extends therefrom.

7. The apparatus of claim 6, wherein the third casing member and the fourth casing member forms a second casing structure, the second casing structure having an air gap in between the third casing member and the fourth casing member.

8. The apparatus of claim 6, wherein the third casing member and the fourth casing member forms a second casing structure, the second casing structure having a dielectric material in between the third casing member and the fourth casing member.

9. The apparatus of claim 1 further comprising:
a third casing member that is placed in proximity to the first arm of the magnetic core and in between the first arm and the first and second conductors and
a fourth casing member that is placed in proximity to the second arm of the magnetic core and in between the second arm and the first and second conductors, wherein the third casing member and second casing member, wherein at least one of the first casing member or the second casing member includes a set of finned structures, including a first fin and a second fin, that extends therefrom.

10. The apparatus of claim 2, further comprising:
a third casing structure comprising a dielectric or insulating material that surrounds the first arm in between the first arm and the first conductor, wherein the third casing structure includes:
(i) a fifth casing member that is placed in proximity to the first conductor and
(ii) a sixth casing member that is placed in proximity to the first conductor, wherein the fifth casing member operatively connects to the sixth casing member to form a second enclosed structure around the first arm and in between the first arm and the first conductor, wherein at least one of the fifth casing member or the sixth casing member includes a third set of finned structures, including a fifth fin and a sixth fin, that extends therefrom.

11. The apparatus of claim 1, further comprising:
a fan or heat exchanger disposed at a terminal end of at least one of the casing members.

12. A method comprising:
providing a magnetic core having (i) a first arm and a second arm and (ii) a first conductor that wraps around the first arm of the magnetic core and a second conductor that wraps around the first arm of the magnetic core, the first conductor wrapping around the second conductor; and
fabricating a casing structure comprising a dielectric or insulating material configured to surround the first conductor and the second conductor, the casing structure having (i) a first casing member that is placed in proximity to the first arm of the magnetic core and (ii) a second casing member that is placed in proximity to the second arm of the magnetic core, wherein at least one of the first casing member or the second casing member includes a set of finned structures, including a first fin and a second fin, that extends therefrom.

13. The method of claim 12 further comprises:
fabricating the first fin and second fin, each having a cooling surface that extends along a portion of the first casing member.

14. The method of claim 12 further comprises:
fabricating the set of finned structures each having a cooling surface that extends along a portion of the first casing member to form a set of cooling channels.

15. The method of claim 13 further comprises:
fabricating the first fin and second fin each having the cooling surface that extends along the portion of the first casing member in a parallel configuration to the first arm or a non-parallel configuration to the first arm.

16. The method of claim 12 method, wherein the casing structure is fabricated by an additive manufacturing process.

17. The method of claim 12, wherein the casing structure is fabricated using a mold formed by an additive manufacturing process.

18. The method of claim 12 further comprising:
fabricating a third casing member that is placed in proximity to the first arm of the magnetic core and in between the first arm and the first and second conductors and fabricating a fourth casing member that is placed in proximity to the second arm of the magnetic core and in between the second arm and the first and second conductors, wherein at least one of the third casing member or the fourth casing member includes a second set of finned structures, including a third fin and a fourth fin, that extends therefrom.

19. The method of claim 18 further comprising:
fabricating the third casing member and the fourth casing member to form a second casing structure, the second casing structure having an air gap in between the third casing member and the fourth casing member.

20. The method of claim 18 further comprising:
fabricating the third casing member and the fourth casing member to form a second casing structure, the second casing structure having a dielectric material in between the third casing member and the fourth casing member.
